(19) United States
(12) Patent Application Publication
(10) Pub. No.: US 2011/0320206 A1
(43) Pub. Date: Dec. 29, 2011

(54) ELECTRONIC BOOK READER AND TEXT TO SPEECH CONVERTING METHOD

(75) Inventors: CHIH-HUNG CHEN, Tu-Cheng (TW); CHIA-HUNG CHIEN, Tu-Cheng (TW); CHIEN-CHOU CHEN, Tu-Cheng (TW)

(73) Assignee: HON HAI PRECISION INDUSTRY CO., LTD., Tu-Cheng (TW)

(21) Appl. No.: 13/092,258

(22) Filed: Apr. 22, 2011

(30) Foreign Application Priority Data
Jun. 29, 2010 (CN) 201010212496.0

(51) Int. Cl. G10L 13/00

(52) U.S. Cl. 704/260; 704/E13.001

(57) ABSTRACT

An electronic book reader includes a text obtaining module, a text highlighting module, a speech synthesis module, a player module, and a synchronization control module. The text obtaining module obtains a selected segment of a text. The text highlighting module highlights the selected segment. The speech synthesis module converts the selected segment into a speech. The player module plays the speech. The synchronization control module sends the selected segment to the text highlighting module and speech synthesis module synchronously.

This application is related to co-pending U.S. patent application entitled “ELECTRONIC BOOK READER”, Attorney Docket No. US33481, US application number ______ filed on ______.

### BACKGROUND

1. Technical Field

The present disclosure relates to electronic book readers, and particularly to, an electronic book reader and a text to speech converting method.

2. Description of Related Art

An electronic book (e-book) is a text file providing the digital media equivalent of a conventional printed book. E-books are usually read on personal computers or smart phones, or on dedicated hardware devices known as e-book readers. An e-book reader usually has a player to play the texts of the e-books. However, user may not know which part is being played due to inattention.

Therefore, there is room for improvement within the art.

### BRIEF DESCRIPTION OF THE DRAWINGS

Many aspects of the embodiments can be better understood with references to the following drawings. The components in the drawings are not necessarily drawn to scale, the emphasis instead being placed upon clearly illustrating the principles of the embodiments. Moreover, in the drawings, like reference numerals designate corresponding parts throughout the several views.

FIG. 1 is a block diagram of an embodiment of the electronic book reader.

FIG. 2 is a flow chart in accordance with an embodiment of a text to speech converting method of the electronic book reader.

### DETAILED DESCRIPTION

The disclosure is illustrated by way of example and not by way of limitation in the figures of the accompanying drawings in which like references indicate similar elements. It should be noted that references to “an” or “one” embodiment in this disclosure are not necessarily to the same embodiment, and such references mean at least one.

In general, the word “module,” as used herein, refers to logic embodied in hardware or firmware, or to a collection of software instructions, written in a programming language, such as, for example, Java, C, or Assembly. One or more software instructions in the modules may be embedded in firmware, such as an EPROM. It will be appreciated that modules may comprise connected logic units, such as gates and flip-flops, and may comprise programmable units, such as programmable gate arrays or processors. The modules described herein may be implemented as either software and/or hardware modules and may be stored in any type of computer-readable medium or other computer storage device.

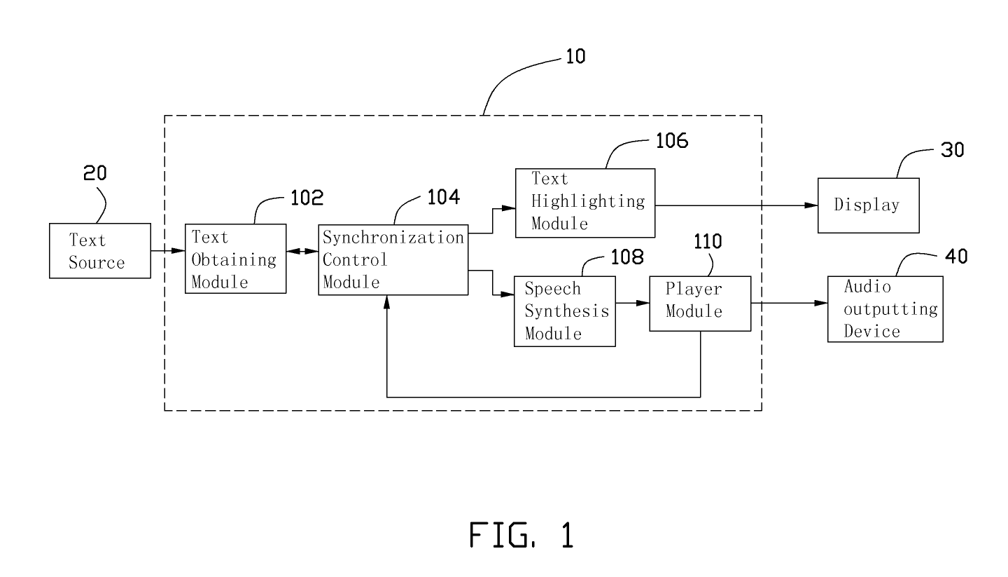

Referring to FIG. 1, an electronic book reader 10 is connected to text source 20, a display 30, and an audio output device 40. In one embodiment, the display 30 is cathode ray tube (CRT) display or liquid crystal display (LCD).

The electronic book reader 10 includes a text obtaining module 102, a synchronization control module 104, a text highlighting module 106, a speech synthesis module 108, and a player module 110. The text obtaining module 102 is connected to the synchronization control module 104. The synchronization control module 104 is connected to the text highlighting module 106 and the speech synthesis module 108. The speech synthesis module 108 is connected to the player module 110. The player module 110 is connected to the audio output device 40 and the synchronization control module 104. The text highlighting module 106 is connected to the display 30.

The display 30 is configured to display texts. The audio output device 40 is configured to output audio signals. In one embodiment, the audio output device 40 is a speaker or headphones. The text obtaining module 102 is configured to divide a text into a plurality of segments according to punctuations of the text, such as commas, periods, question marks, exclamation points, and obtain a selected segment of the text from the text source 20.

The synchronization control module 104 is configured to send the selected segment to the text highlighting module 106 and the speech synthesis module 108 at the same time. The synchronization control module 104 is further configured to receive a feedback message from the player module 110 and then send a revoking command for revoking the highlighting effect of the text to the text highlighting module 106. The speech synthesis module 108 is configured to convert the selected segment to speech and send the speech to the player module 110 to play. The player module 110 is configured to play the speech and a feedback message to the synchronization control module 104 after playing the speech. The feedback message indicates that the player module 110 finishes playing the speech.

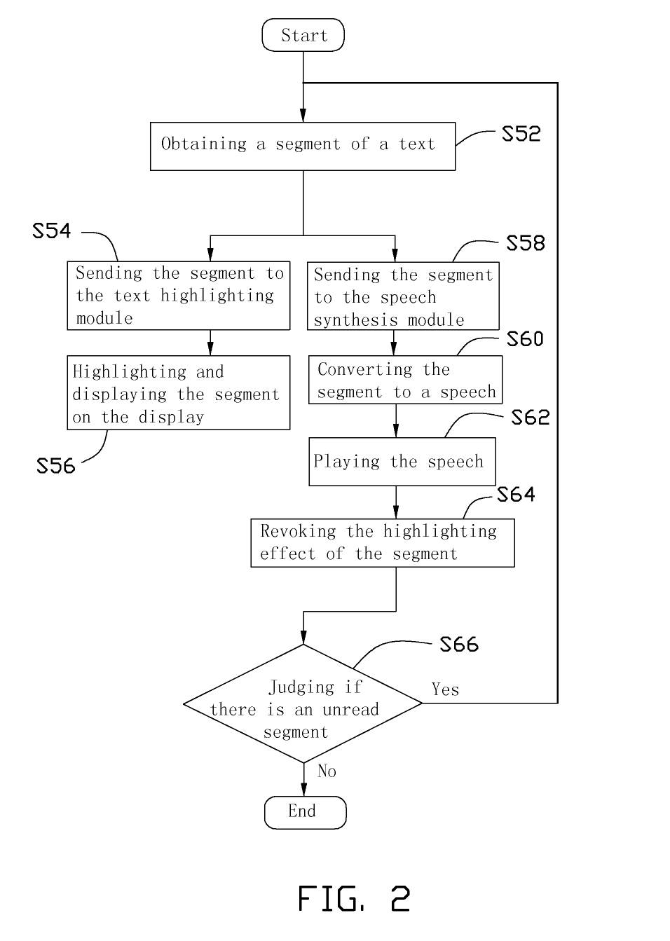

Referring to FIG. 2, a text to speech converting method on the electronic book reader is shown. An embodiment of the method is as follows.

In step S52, the text obtaining module 102 obtains a selected segment of a text from the text source 20. In one embodiment, the selected segment is a sentence. The text includes a plurality of sentences. Two adjacent sentences of the text are separated by punctuation.

In step S54, the synchronization control module 104 sends the selected segment to the text highlighting module 106.

In step S56, the text highlighting module 106 highlights the selected segment and displays the segment on the display 30.

In step S58, the synchronization control module 104 sends the selected segment to the speech synthesis module 108, when the synchronization control module 104 sends the segment to the text highlighting module 106.

In step S60, the speech synthesis module 108 converts the selected segment to speech and sends the speech to the player module 110.

In step S62, the player module 110 plays the speech from the speech synthesis module 108 and then sends a feedback message to the synchronization control module 104.

In step S64, the synchronization control module 104 sends a revoking command for revoking the highlighting effect of the text to the text highlighting module 106, and the text highlighting module 106 revokes the highlighting effect of the segment.

In step S66, the synchronization control module 104 sends a message for reading the next segment of the text to the text obtaining module 102. The text obtaining module 102 judges if there is unread segment of the text. If so, turns to step S52, if not, the process is over.

It is to be understood, however, that even though numerous characteristics and advantages of the embodiments have been set forth in the foregoing description, together with details of the structure and function of the embodiments, the disclosure is illustrative only, and changes may be made in detail, especially in matters of shape, size, and arrangement of parts within the principles of the present disclosure to the full extent indicated by the broad general meaning of the terms in which the appended claims are expressed.

Depending on the embodiment, certain of the steps of methods described may be removed, others may be added, and the sequence of steps may be altered. It is also to be understood that the description and the claims drawn to a method may include some indication in reference to certain steps. However, the indication used is only to be viewed for identification purposes and not as a suggestion as to an order for the steps.

What is claimed is:

1. An electronic book reader, comprising:
a text obtaining module, the text obtaining module configured to obtain a selected segment of a text;
a text highlighting module, the text highlighting module configured to highlight the selected segment and display the selected segment on a display;
a speech synthesis module, the speech synthesis module configured to convert the selected segment into speech;
a player module, the player module configured to play the speech; and
a synchronization control module, the synchronization control module configured to send the selected segment to the text highlighting module and the speech synthesis module contemporaneously.

2. The electronic book reader of claim 1, wherein the selected segment is a part of the text with a punctuation.

3. The electronic book reader of claim 1, wherein the player module is configured to send a feedback message to the synchronization control module after playing the speech, and the feedback message indicates that the player module finishes playing the speech.

4. The electronic book reader of claim 1, wherein the text highlighting module is configured to revoke highlight effect of the selected segment after the player module finishes playing the speech.

5. A text to speech converting method comprising:
obtaining a selected segment of text;
highlighting and displaying the selected segment, and converting the selected segment into speech synchronously; and
playing the speech.

6. The text to speech converting method of claim 5, further comprising revoking highlight effect of the selected segment after playing the speech.

7. The text to speech converting method of claim 5, wherein the selected segment is a sentence of the text.

8. A text to speech converting method comprising:
providing an electronic book reader, the electronic book reader comprising:
a text obtaining module, the text obtaining module configured to obtain a selected segment of text;
a text highlighting module, the text highlighting module configured to highlight the selected segment and display the selected segment on a display;
a speech synthesis module, the speech synthesis module configured to convert the selected segment into speech;
a player module, the player module configured to play the speech; and
a synchronization control module, the synchronization control module configured to send the selected segment to the text highlighting module and the speech synthesis module contemporaneously;
the text obtaining module obtaining the selected segment of text;
the text highlighting module highlighting and displaying the selected segment, and the speech synthesis module converting the selected segment into the speech contemporaneously; and
the player module playing the speech.
